(19) United States
(12) Patent Application Publication
(10) Pub. No.: US 2024/0133124 A1
(43) Pub. Date: Apr. 25, 2024

(54) Hollow sleeper

(71) Applicant: SCHWIHAG AG, Tägerwilen (CH)

(72) Inventor: Roland BUDA, Radolfzell am Bodensee (DE)

(73) Assignee: SCHWIHAG AG, Tägerwilen (CH)

(21) Appl. No.: 18/489,984

(22) Filed: Oct. 18, 2023

(30) Foreign Application Priority Data
Oct. 19, 2022 (DE) 10 2022 127 736.4

(51) Int. Cl. E01B 3/30

(52) U.S. Cl. CPC E01B 3/30

(57) ABSTRACT

A precast concrete hollow sleeper for use in railway tracks has a body with at least one upper bearing surface for rails and one cavity extending over the entire length of the hollow sleeper and surrounded by the body on at least three sides for accommodating and possibly removing cable crossings and/or switch drive mechanisms and/or equipment for track or train control and/or measuring devices and/or supply lines. The body is made of concrete, preferably concrete with additional reinforcement.

### CROSS-REFERENCE TO RELATED APPLICATION

This application claims the benefit of German Patent Application DE 10 2022 127 736.4, filed on Oct. 20, 2022, the contents of which is incorporated in its entirety.

### BACKGROUND

Hollow sleepers are used in railway track construction to allow cables to be laid underneath the rails across the track, to enable problem-free assembly of the linkage of a switch drive, or to accommodate special measuring equipment within the hollow sleeper without the need for tracks to be removed or for cables or other devices to be disconnected during installation, removal or maintenance.

For this purpose, hollow sleepers for railway tracks have a body which encloses a cavity at least on three sides, preferably open at the top, with the top or the tops of the hollow sleeper providing bearing surfaces for tracks to be screwed to the hollow sleepers. The hollow sleepers must have a cavity that is sufficient for inserting cables, in the case of the so-called cable guide sleeper, or for the drive mechanism of a switch drive, in the case of the so-called points lock sleeper, or for electronic or mechanical equipment for the control of track infrastructure and rolling stock (trains).

The hollow sleepers are designed in such a way that they can absorb all forces transmitted by the train during operation under all environmental conditions without damage. The usual service life for these products is at least 50 years.

The rails are fastened to the sleepers by means of rail fastening systems, which in turn are mounted on the sleeper body.

Usually, such hollow sleepers have a cross section that is substantially U-shaped with a base and legs that extend upwards from this base. On the top of these legs, in turn, the above-mentioned bearing surfaces for mounting rails are usually arranged. In this area, there may be deviations from the U-shape of the hollow sleeper, in particular in order to make the bearing surfaces larger than the basic shape of the side legs.

This enables problem-free installation of both the linkage of the switch drive or special measuring devices or the passage of cables, supply lines or the like. Such hollow sleepers are widely used in track construction.

The hollow sleepers known from the prior art are usually made of cast iron or steel, and are therefore either primary formed in the casting process or provided as a welded or forged construction. The manufacturing of such hollow sleepers is time-consuming and expensive.

### SUMMARY

The present disclosure provides a hollow sleeper which, with at least the same mechanical load-bearing capacity as compared to conventional hollow sleepers, can be produced more simply, easily, and cost-effectively.

The hollow sleeper is provided for use in railway tracks, with a body having at least one upper bearing surface for rails, preferably two upper bearing surfaces for one rail each, and one cavity extending over the entire length of the hollow sleeper surrounded by the body on at least three sides for accommodating and optionally removing cable crossings and/or switch drive mechanisms and/or equipment for track or train control and/or measuring devices and/or supply lines. The body is made of concrete, preferably precast concrete with an additional reinforcement.

This provides a hollow sleeper that is capable of absorbing all the forces transmitted by the train during operation under all environmental conditions without causing damage, while also ensuring the requirements for the service life of these products. The hollow sleepers can be made in a simple cold manufacturing process by casting concrete. Unlike the high-energy and complex cast iron production or welding and forging technology used in known hollow sleeper production, casting concrete allows for a large variety of hollow shapes to be produced. In addition, possible electromagnetic induction effects that arise in the case of a steel sleeper are reduced or completely prevented when high-voltage cables are routed through the concrete sleeper. Further, the hollow sleeper made of concrete also allows for the first time the use of plastic dowels or standard concrete anchors for fastening the rail anchor.

It is preferred if the hollow sleeper consists of a single piece precast body that can be produced in a single production step by pouring concrete into a mold, preferably into a mold with a previously introduced reinforcement. Such production preferably also includes from the outset the formation of possibly reinforced bearing surfaces for rail fastening systems and/or the provision of holes for receiving dowels and/or the embedding of steel threads during the manufacturing process of the hollow sleeper.

It is preferred if the geometry of the hollow sleeper is substantially the same over its entire length. The length of the hollow sleeper spans at least the normalized distance between two rails carried by the hollow sleeper. The cavity, as already mentioned above, extends over the entire length of the hollow sleeper in order to fulfill the intended purpose of the cavity. Even if bearing surfaces for the rails in the upper area of the hollow sleeper may be wider than the upper edges of a U-shaped hollow sleeper, for example, this does not deviate from the substantially similar cross section or the substantially similar geometry of the hollow sleeper. It is preferred if the cross section of the body has a U-shape with a base, and legs extending upwards from the base on both sides. The terms “above” or “below” or “ground” refer to operational use in which the base of a hollow sleeper rests on the track bed or a slab track and the legs extend from the base in the direction of the rails to be supported.

It is preferred if the legs of this U-shape have the same height, in order to ensure that tracks can be laid safely and horizontally on the hollow sleeper.

It is also preferred if the legs extend upwards from the base, forming a right angle)(+/−5°. This provides a particularly simple and easy-to-manufacture body for a hollow sleeper. The manufacturing method and the materials used for the production of the precast concrete hollow sleeper in principle allow for a large variety of cross-sectional shapes or cross-sectional variants to account for specific needs depending on the intended use or customer requirements.

It is preferred if the concrete used to produce the hollow sleeper is high-strength concrete, glass fiber reinforced concrete, carbon fiber reinforced concrete or ceramic fiber reinforced concrete, preferably a mixture of at least two of these concretes. In this way, a material or a mixture of materials is made available which is particularly suitable for setting any desired mechanical property and service life, even under challenging environmental conditions, using readily available materials.

Moreover, it is particularly preferred if the reinforcement, which is embedded in the concrete, comprises glass fiber fabric and/or carbon fiber fabric and/or ceramic fiber fabric. This creates the possibility of improving and setting the desired mechanical properties of the hollow sleeper in almost any way using light, easily available and workable materials.

In a further preferred embodiment, the reinforcement includes carbon fiber rods and/or glass fiber rods and/or ceramic fiber rods and/or steel rods, which in a particularly preferred embodiment are prestressed and embedded in the concrete of the body. This allows producing a particularly robust and permanently operable hollow sleeper with materials that are easy to control and commercially available.

A hollow sleeper is also preferred, which is characterized in that the reinforcement comprises carbon fiber textiles, particularly preferably a combination of carbon fiber textiles and prestressed carbon fiber rods. Material combinations of this type are lighter and easier to process than the metal materials used in the prior art and also offer at least comparable mechanical stability and strength when used in connection with concrete.

It is also preferred if the body includes a sleeper pad made of elastic material on one outer side, preferably below the base. This sleeper pad can be provided from the outset during the manufacturing process for the hollow sleeper or easily attached to the body of the hollow sleeper using commercially available means in order to provide the necessary cushioning and increase the transverse displacement resistance of the hollow sleeper against the track bed under load.

It is also preferred if sensors, preferably sensors for track monitoring and/or for monitoring the material condition of the hollow sleeper, are connected to the body, preferably embedded in the body. The cold production of the hollow sleeper allows for the first time the embedding of commercially available sensors compared to the hot production according to the prior art. By integrating sensors a hollow sleeper is obtained that can be used in many ways and is easy to monitor.

The concrete material of the hollow sleeper is electrically non-conductive. This contrasts to metallic materials used in the prior art. The precast concrete hollow sleeper can therefore be used without additional electrical insulation in the area of the bearing surfaces for rails. Even without electrical insulation an undesired flow of electric current between two rails connected to the hollow sleeper is prevented.

Finally, the disclosure also provides a system comprising a hollow sleeper and a track construction, preferably comprising two rails running parallel and detachably connected to a hollow sleeper at the upper bearing surfaces. With the system, the same technical effects and advantages are achieved as with the precast concrete hollow sleeper.

### BRIEF DESCRIPTION OF THE DRAWINGS

The invention is explained in more detail below with reference to three figures.

FIG. 1a shows two hollow sleepers with high-voltage cables running in their cavities.

FIG. 1B shows a precast concrete hollow sleeper made of concrete reinforced with carbon textile fabric and carbon fiber rods.

FIG. 2a shows a cross section through a hollow sleeper.

FIG. 2b shows a perspective view of a hollow sleeper.

FIG. 3 shows a plurality of cross-sectional variants and variants for rail bearing surfaces.

### DETAILED DESCRIPTION

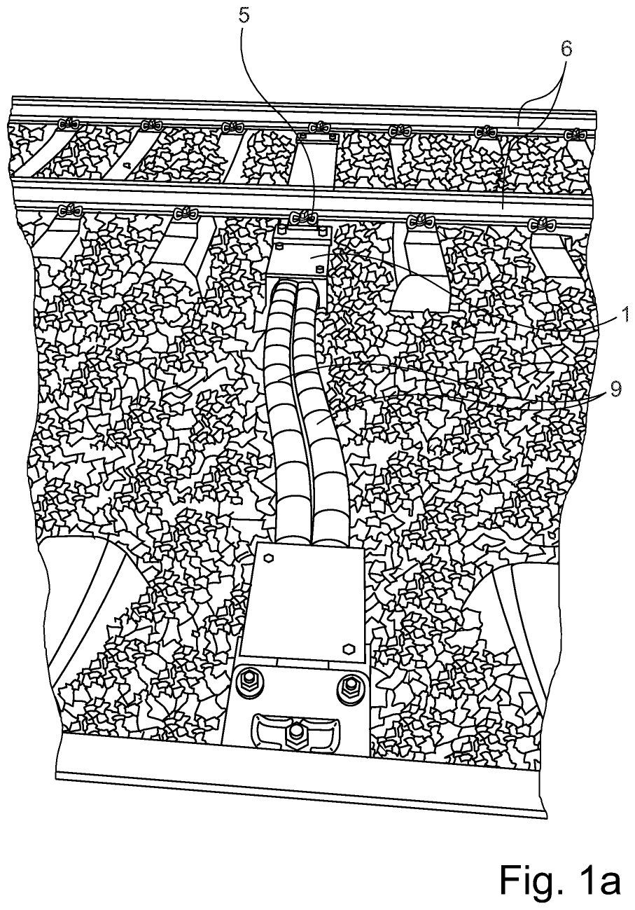

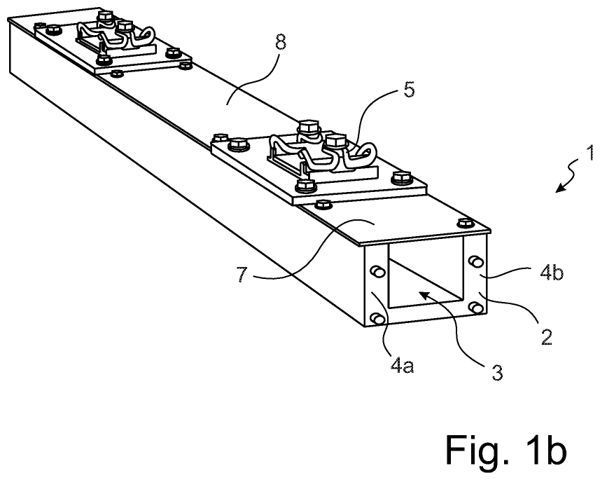

FIG. 1a shows two hollow sleepers 1 which are used for crossing two power cables 9 in a double track. The rails 6 of the tracks are each fastened to the cable guide sleepers or hollow sleepers 1 by rail fasteners 5.

FIG. 1B shows the hollow sleeper 1 with a substantially U-shaped body 2 and a cavity 3 surrounded on three sides by the body 2. Rail fastening systems 5 are arranged on the tops of the legs 4a, 4b of the body 2, with which rails 6 can be connected to the hollow sleepers 1. Cables can be arranged in the cavity 3 in such a way that they do not protrude beyond the legs 4a, 4b of the body 2. The cables can thus be exchanged without removing the rails from the hollow sleepers 1. After inserting the cables, the covers 8 and 7 made of steel or plastic material can be screwed to the body 2 on top of the legs 4a, 4b.

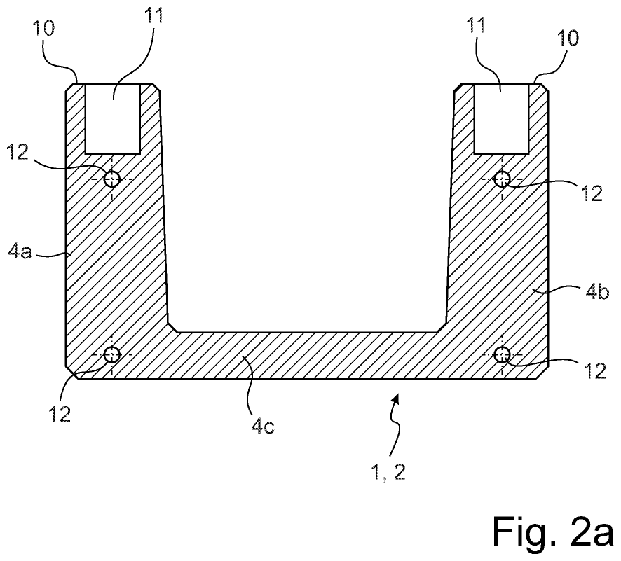

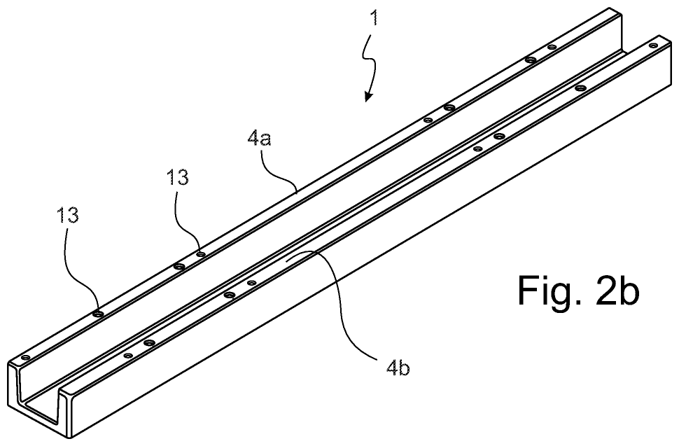

FIG. 2a shows a cross section through a hollow sleeper 1. The cross section is substantially U-shaped with a base 4c and two legs 4a, 4b extending upwards from the base 4c. Bearing surfaces 10 for rail fastening systems and rails can be seen on the top of the legs 4a, 4b. Sleeves 11 are provided during the production of the hollow sleeper 1 for receiving fastening systems. The figure also shows the position of four carbon rods 12 which are embedded under prestress in the concrete body 2 in order to thereby provide a reinforced concrete body 2.

FIG. 2b shows a perspective view of a hollow sleeper 1, which in the embodiment shown has a length of 2.6 m and has 8 holes 13 each on the tops of the legs 4a 4b, into which the fastening screws and/or dowels of the fastening systems for rails can be introduced. The holes 13 may be precast into the body or bores.

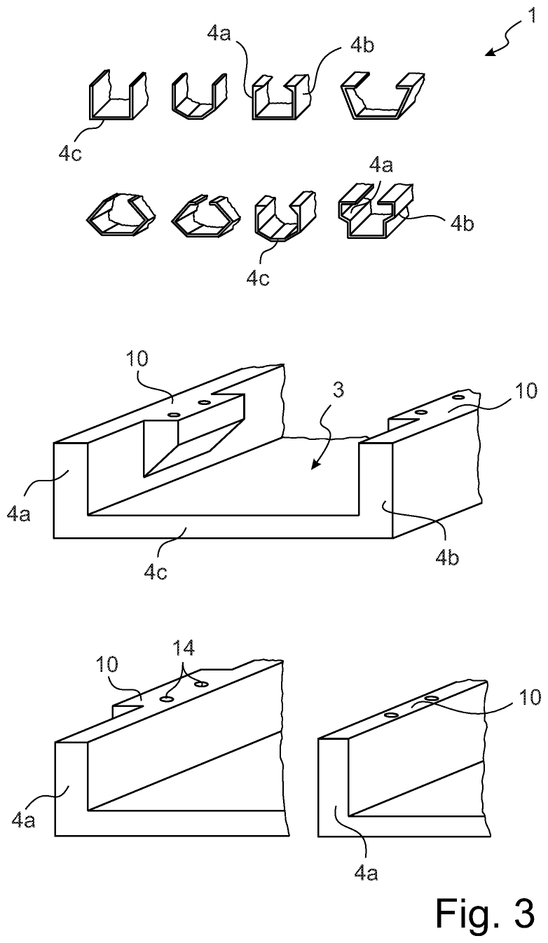

FIG. 3 shows a variety of substantially U-shaped cross-sectional variants for a precast concrete hollow sleeper 1. All of the illustrated examples have a base 4c and two legs 4a, 4b, which extend upwards from this base and have bearing surfaces 10 for rails and rail fastening systems at their tops. The legs 4a, 4b and the base 4c define a cavity 3 in which supply lines or the like can be inserted.

FIG. 3 also shows variants in the area of the rail anchor, in particular a first variant in which a widening is provided in the upper area of the leg 4a, which is integrally connected to the leg 4a. Both bearing surfaces 10 also have two blind holes 14 into which threaded bushings or dowels can be inserted for fastening rail fastening systems or rails. A second variant shows bearing surfaces 10, which are located outwards from the leg 4a in the area of the bearing surface 10 for rails, in order to provide a broadened bearing surface 10 for rail fastening systems or rails, just like in the first variant. Finally, a third variant shows a section of a substantially U-shaped hollow sleeper 1 with concrete anchors with threads or dowels inserted in the illustrated legs 4a, 4b.

### REFERENCE SIGNS

1 hollow sleeper
2 body
3 cavity
4a, 4b legs
4c base
5 rail fastening systems
6 rails
7, 8 covers
9 cables
10 bearing surfaces
11 sleeves
12 carbon rods
13 bores
14 blind holes

What is claimed is:

1. A hollow sleeper (1) for use in railway tracks, comprising:
a body (2) having at least one upper bearing surface (10) for rails; and
a cavity (3) surrounded by the body (2) on at least three sides for accommodating and possibly removing cables and/or switch drive mechanisms and/or equipment for track or train control and/or measuring devices and/or supply lines,
wherein the body (2) is made of concrete.

2. The hollow sleeper (1) according to claim 1, wherein the concrete comprises a reinforcement.

3. The hollow sleeper (1) according to claim 2,
wherein the reinforcement comprises glass fiber fabric and/or carbon fiber fabric and/or ceramic fiber fabric.

4. The hollow sleeper (1) according to claim 2, wherein the reinforcement comprises rods selected from the group consisting of carbon fiber rods (12), glass fiber rods, ceramic fiber rods, and steel rods.

5. The hollow sleeper (1) according to claim 4, wherein the rods (12) are embedded prestressed in the concrete of the body (2).

6. The hollow sleeper (1) according to claim 2, wherein the reinforcement comprises a combination of carbon fiber textiles and preferably prestressed carbon fiber rods (12).

7. The hollow sleeper (1) according to claim 1, wherein the hollow sleeper (1) consists of a single cast body.

8. The hollow sleeper (1) according to claim 1, wherein a geometry of the hollow sleeper (1) is substantially the same over its entire length.

9. The hollow sleeper (1) according to claim 1, wherein a cross section of the body (2) is U-shaped, having a base (4c) and legs (4a, 4b) extending upwards from both sides of the base (4c).

10. The hollow sleeper (1) according to claim 9, wherein the legs (4a, 4b) have the same height.

11. The hollow sleeper (1) according to claim 9, wherein the legs (4a, 4b) extend upwards from the base (4c) at a right angle.

12. The hollow sleeper (1) according to claim 9, further comprising a sleeper pad made of elastic material arranged below the base (4c).

13. The hollow sleeper (1) according to claim 1, wherein the concrete is a high-strength concrete, a glass fiber reinforced concrete, a carbon fiber reinforced concrete, a ceramic fiber reinforced concrete, or a mixture of at least two of thereof.

14. The hollow sleeper (1) according to claim 1, further comprising a sensor for track monitoring and/or for monitoring a material condition of the hollow sleeper (1) embedded in the body (2).

15. The hollow sleeper (1) according to claim 1, wherein the hollow sleeper (1) has no additional electrical insulation in an area of the at least one upper bearing surface (10) for rails.

16. A track structure, comprising:
the hollow sleeper (1) according to claim 1, and
two parallel rails detachably connected to the at least one upper bearing surface (10).

17. A hollow sleeper (1) for use in railway tracks, comprising:
a precast concrete body (2) having a U-shaped cross section including a base, and two legs extending upwardly from the base;
a cavity (3) formed within the precast concrete body (2) between the base and the two legs, the cavity (3) being suitable for accommodating one or more of cables, switch drive mechanisms, equipment for track or train control, measuring devices, and supply lines; and
a bearing surface (10) for rails formed on top of the legs,
wherein the precast concrete body is made of glass fiber reinforced concrete, carbon fiber reinforced concrete, ceramic fiber reinforced concrete, or a mixture thereof.
